(19) United States
(12) Patent Application Publication
(10) Pub. No.: US 2014/0331131 A1
(43) Pub. Date: Nov. 6, 2014

(54) Accessible Self-Service Kiosk

(71) Applicants: Autumn Brandy DeSellem, Columbus, OH (US); Ronald Gedrich, Columbus, OH (US)

(72) Inventors: Autumn Brandy DeSellem, Columbus, OH (US); Ronald Gedrich, Columbus, OH (US)

(21) Appl. No.: 13/918,190

(22) Filed: Jun. 14, 2013

Related U.S. Application Data
(60) Provisional application No. 61/818,731, filed on May 2, 2013.

(51) Int. Cl. G06F 3/0484

(52) U.S. Cl. CPC G06F 3/0484
USPC 715/708

(57) ABSTRACT

Accessible self-service kiosks are disclosed. In one embodiment, a method for interacting with an accessible self-service kiosk may include (1) receiving, from a user, identifying information; (2) retrieving information about the user based on the identifying information; (3) receiving an instruction from the user to enter an accessibility mode; and (4) interacting with the user with an accessible interface.

### RELATED APPLICATIONS

This patent application is related to U.S. Provisional Patent Application Ser. No. 61/818,731, filed May 2, 2013, the disclosure of which is incorporated by reference in its entirety.

### BACKGROUND OF THE INVENTION

1. Field of the Invention

The present invention generally relates to interactive devices, and, more specifically, to accessible self-service kiosks.

2. Description of the Related Art

Self-service kiosks are becoming ubiquitous. Nowadays, it is common for customers to interact with self-service devices for banking, purchasing movie tickets, checking-in for a flight, and even to check-out of a grocery store. Indeed, customers expect these self-service devices to be provided from a business or service provider.

### SUMMARY OF THE INVENTION

Accessible self-service kiosks are disclosed. In one embodiment, a method for interacting with a user of an accessible self-service kiosk may include (1) receiving, from a user, identifying information; (2) retrieving information about the user based on the identifying information; (3) receiving an instruction from the user to enter an accessibility mode; and (4) interacting with the user with an accessible interface.

In one embodiment, the identifying information may be read from an identifying device, such as a transaction card. In one embodiment, the identifying information may be received from the identifying device without contact.

In one embodiment, the received information may include at least one user accessible preference.

In one embodiment, the instruction to enter an accessibility mode may be a gesture, a verbal command, etc. In one embodiment, the instruction may be received on a keypad.

In one embodiment, the step of interacting with the user with an accessible interface may include displaying to the user an instruction screen that includes instructions on how to interact with the self-service kiosk; and displaying a guide to user interaction with the self-service kiosk on at least one additional screen.

In one embodiment, the method may further include providing white noise to a periphery of the self-service kiosk to mask audible communications between the user and the self-service kiosk.

According to another embodiment, a method for interacting with a user of an accessible self-service kiosk is disclosed. The method may include (1) sensing, by at least one sensor, the presence of a user at a self-service kiosk; (2) determining, based on data from the at least one sensor, that the user is likely to use accessibility mode for interacting with the self-service kiosk; and (3) interacting with the user in the accessibility mode.

In one embodiment, the at least one sensor may include an infrared sensor that may detect the presence of the user at the self-service kiosk.

In another embodiment, the at least one sensor may include a weight sensor that may detect the presence of the user at the self-service kiosk.

In one embodiment, the at least one sensor may sense a height of the user.

In one embodiment, the at least one sensor may detect the presence of metal at the self-service kiosk.

In one embodiment, the accessibility mode may be initiated when a sensed height of the user a threshold height.

In one embodiment, the accessibility mode may be initiated when metal is detected.
16. The method of claim 14, wherein the accessibility mode is initiated when a certain movement is detected.

In one embodiment, the step of interacting with the user in the accessibility mode may include displaying to the user an instruction screen that includes instructions on how to interact with the self-service kiosk; and displaying a guide to user interaction with the self-service kiosk on at least one additional screen.

In one embodiment, the step of interacting with the user in the accessibility mode may include adjusting a position of at least one display to accommodate the sensed height of the user.

In one embodiment, the step of interacting with the user in the accessibility mode may include adjusting a position of at least one controller to accommodate the sensed height of the user.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of a system including an accessible self-service kiosk according to one embodiment;

FIG. 2 is a block diagram of an accessible self-service kiosk according to one embodiment;

FIG. 3 is an example of keypad for use in an accessible self-service kiosk according to one embodiment;

FIG. 4 is a flowchart depicting a method of using an accessible kiosk according to one embodiment;

FIGS. 5A-5F depict exemplary screens from a self-service kiosk according to embodiments;

FIG. 6 depicts a rotatable screen assembly according to one embodiment;

FIG. 7 depicts a sanitary screen assembly according to one embodiment; and

FIG. 8 depicts a sanitary screen assembly according to another embodiment.

### DETAILED DESCRIPTION OF PREFERRED EMBODIMENTS

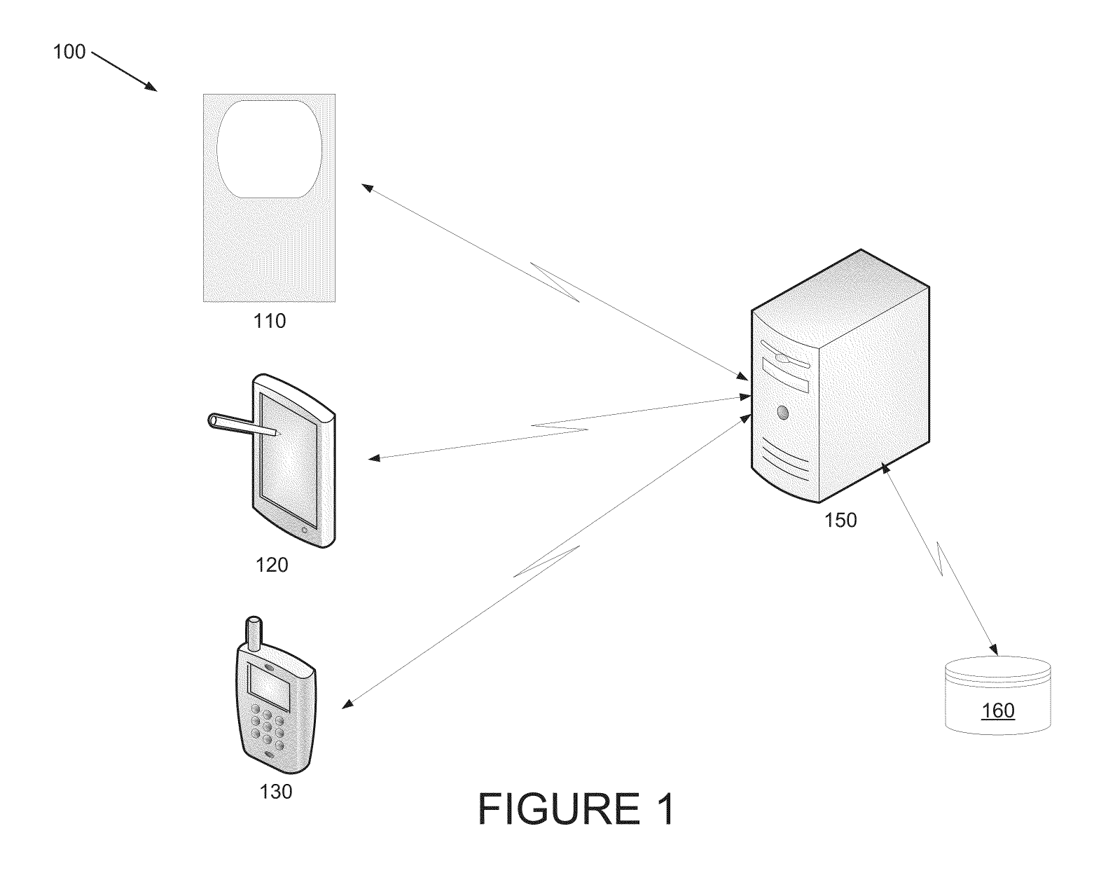

Several embodiments of the present invention and their advantages may be understood by referring to FIGS. 1-8, wherein like reference numerals refer to like elements.

According to embodiments of the invention, self-service banking kiosks are provided that may include features such as touch screens, joysticks, voice response systems, etc. in order to make the kiosks more accessible and available to all individuals. For example, the features described herein may be used to comply with the Americans with Disabilities Act, or “ADA.”

In one embodiment, an accessibility button, icon, etc. may be provided on a screen, which in one embodiment may be a touch screen. The button or icon may be located at the bottom or gutter portion of the screen, below the screen, etc. to ensure that all persons can reach it. When actuated, an accessibility mode may be activated. In this, mode the keypad may be used to navigate the screen and control each interface. Thus, instead of touching buttons on the screen, the keypad buttons may be used in a “joystick” mode. Various layouts are possible for control of the cursor for selection. The button configurations may be customizable by the user and stored as part of a user's preferences.

In one embodiment, when first actuated, a tutorial screen may be provided with instructions for operation. Visual cues may be provided on each screen to guide the user. The user may then be returned to the initial screen or page from which the tutorial was activated. This tutorial may be activated at any time from any screen.

In one embodiment, the tutorial (or shortcuts) may be displayed on the user's mobile electronic device, in Google Glass, etc.

Shortcuts may be used to enable quicker navigation with minimal keystrokes or user input. For example, each menu option on a particular screen may be assigned, or mapped to, a number that corresponds to the keypad for selection.

In this accessibility mode, the functionality of the original keypad may be preserved as much as possible. For example, the number keys may function for number entry rather than being altered for joystick control. In one embodiment, the function of the keypad may be toggled between number key entry and screen navigation.

Additional features may be included as necessary and/or desired. Examples of such features include voice recognition/control, lip reading, portable or mobile device interfacing, foot pedal(s), holographic or gesture inputs, etc. In the case of voice control, white noise, noise cancellation, etc. may be used as a method of masking the voice interaction between the user and the device to prevent eavesdropping during the user's session in conducting a transaction.

Although the disclosure may be made in the context of financial services kiosks, its applicability is not so limited. The features may be used with any interactive device having a touch interface, including airline check-in/reservation kiosks, venue (e.g., movie theater, sporting event, etc.) ticket kiosks, vending machines, trade show information displays, restaurant ordering devices, transportation ticket devices, etc. The disclosure may further have applicability to interactive devices having touch screens, such as tablet computers, smart phones, desktop computers, laptop computers, navigation systems, vehicles, e-reading devices, etc.

The disclosures of the following are hereby incorporated, by reference, in their entireties: U.S. Pat. Nos. 7,099,850; 7,103,576; 7,783,578; 6,685,088; 7,448,538; and 7,657,489 and U.S. patent application Ser. Nos. 11/398,281; 11/822,708; 12/421,915; 12/819,673; 12/914,288; 13/168,148; 61/585,057; 13/492,126; 13/456,818, 13/788,582, and 61/745,151.

Referring to FIG. 1, a diagram of system including an accessible self-service kiosk is provided. System 100 may include kiosk 110, portable electronic device 120, smart phone 130, server 150, and database 160. In one embodiment, kiosk 110 may be a self-service kiosk, for example, a banking kiosk such as an automated teller machine. In another embodiment, kiosk 110 may be an airline check-in/reservation kiosk, a venue ticket kiosk, a vending machine, a trade show information kiosk, a restaurant ordering kiosk, transportation ticket kiosk, a grocery store kiosk, etc.

Portable electronic device 120 may be any suitable interactive device including, for example, tablet computers, laptop computers, electronic reading devices, etc. Any suitable electronic device may be used as necessary and/or desired.

In one embodiment, portable electronic device 120 may be Goggle's Glass.

Smart phone 130 may be any interactive communication device. Examples include the Apple iPhone, the Samsung Galaxy, etc.

Server 150 may be a centralized server that may communicate with any or all of kiosk 110, portable electronic device 120, and smart phone 130. In one embodiment, server 150 may communicate with database 160. Database 160 may store customer data, including, for example, account information, customer preferences, etc.

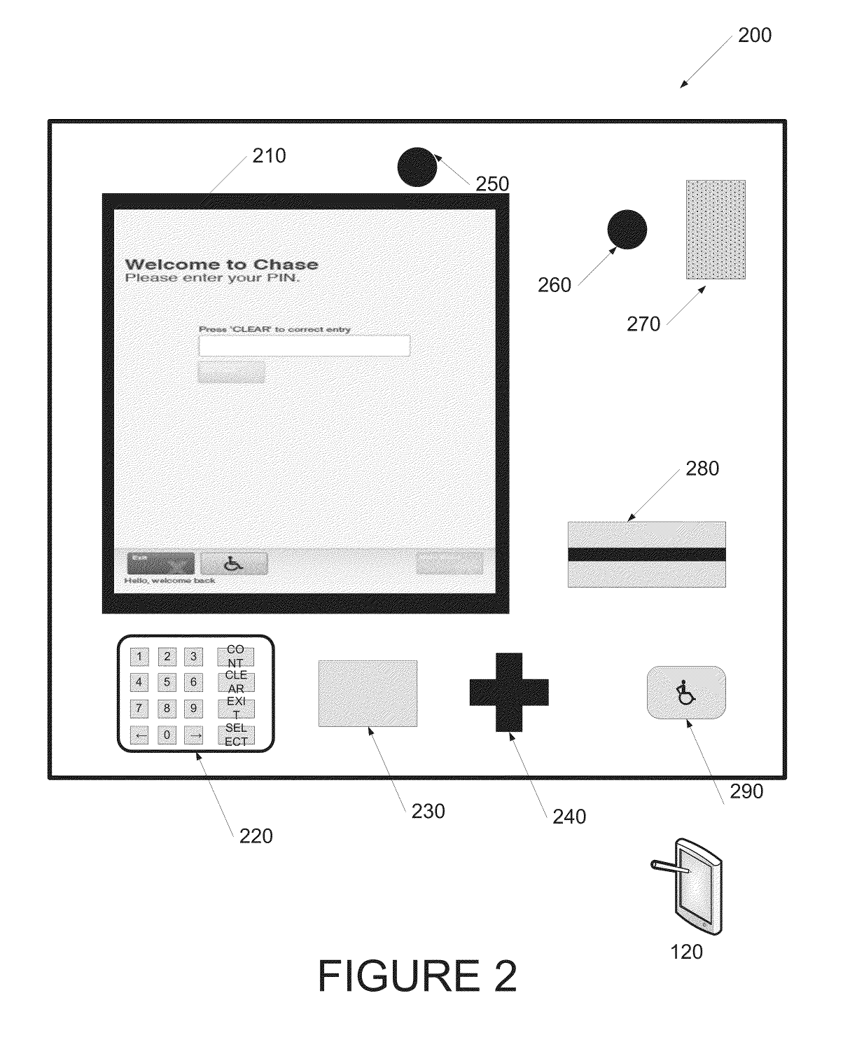

Referring to FIG. 2, a block diagram of an accessible self-service kiosk according to one embodiment is provided. Accessible kiosk 200 may include, for example, screen 210, keypad 220, touchpad 230, joystick/direction control 240 (e.g., trackball, joypad, etc.), and accessibility mode button 290.

In one embodiment, accessible kiosk 200 may further include camera 250, microphone 260, speaker 270, and card slot 280. Various sensors (not shown), including, for example, height sensors, weight sensors, temperature sensors, etc. may be provided to detect the presence and/or physical characteristics of a customer.

Screen 210 may be any suitable screen, and may be a touch screen or a non-touch screen. In one embodiment, multiple screens may be provided as necessary and/or desired. In one embodiment, screen 210 may be movable, vertically and/or horizontally, to adjust to a proper sensed position for a customer using sensors (not shown).

An example of such a movable screen/display is provided in U.S. patent application Ser. No. 13/456,818, the disclosure of which is incorporated, by reference, in its entirety.

In one embodiment, screen 210 may be a holographic screen. For example, screen 210 may be provided on a platform that extends from, or pulls out from, the kiosk. A medium for a holographic image may be provided on the platform.

In another embodiment, screen 210 may be a three-dimensional (“3D”) screen. The user may be required to wear special glasses in order to properly view the screen.

In one embodiment, sensors may sense motions and gestures made by the user into the area where the screen or image is projected. In one embodiment, the user may not need to physically touch a screen to cause an action.

In one embodiment, kiosk 200 may interact directly with portable electronic device 120 and/or smart phone 130 (e.g., phone, tablet computer, laptop/notebook computer, e-reading device, Google Glass, etc.). In one embodiment, the screen and input (e.g., touch sensitive layer, keypad, etc.) on the electronic device 120 and/or smart phone 130 may mirror screen 210. In another embodiment, the screen and input on the electronic device 120 and/or smart phone 130 may serve as an input for kiosk 200. In still another embodiment, the screen and input on the electronic device 120 and/or smart phone 130 may display only certain information (e.g., sensitive information, information set in the user's preferences, etc.).

In one embodiment, a mobile application may execute on electronic device 120 and/or smart phone 130, and electronic device 120 and/or smart phone 130 may communicate with kiosk 200 by any suitable communication means (e.g., NFC, Wi-Fi, Bluetooth, etc.).

Keypad 220 may include a suitable number of keys to facilitate data entry. In one embodiment, keypad 220 may include 10 numeric keys (0-9), at least two directional keys, and a plurality of “action keys.” As will be described in more detail below, in one embodiment, the keypad may be used to navigate the screen.

In one embodiment, the user may enter characters by repeatedly pressing a corresponding number key. For example, if the user presses the number “2” once, the number “2” is displayed. With each additional press within a certain time period (e.g., 1 second), an assigned letter (e.g., “A”, “B”, “C”) or symbol may be displayed.

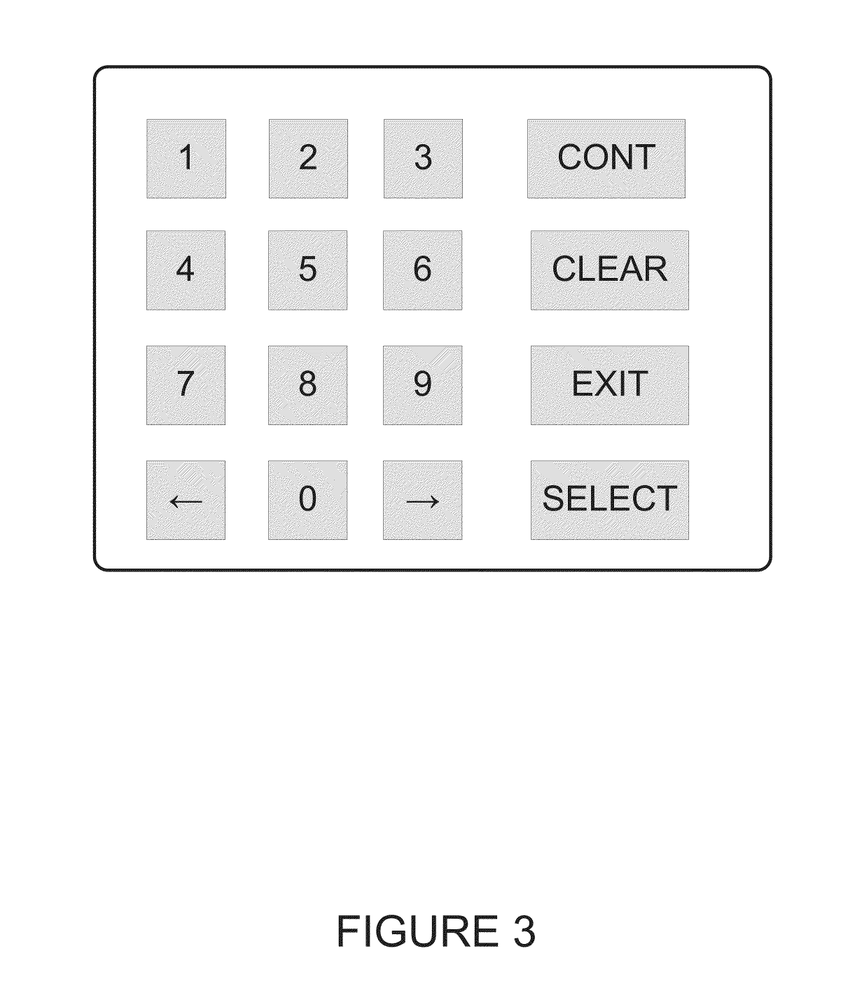

An example of keypad 220 is provided in FIG. 3.

In one embodiment, the keypad may “float.” For example, if a vision impaired customer wants to type his or her PIN on a touch screen device, the customer may place three fingers (e.g., index, middle, ring fingers) on a touch screen, touch pad, etc. Regardless of where the fingers are placed, the screen would automatically position the electronic keypad with the leftmost finger as the 4 button, middle as the 5 button, and rightmost as the 6 button.

Thus, if the customer wants to enter a 1, 2, 3 the customer would move the appropriate finger up and strike a “key.” If the customer wants to enter a 7, 8, 9, the customer would move the appropriate finger down and strike a “key”.

Other arrangements, for the keypad may be used as necessary and/or desired. In one embodiment, the user may set the keypad that the user may wish to use as a preference. Thus, any arrangement that a user may desire may be possible.

In another embodiment, additional keys may be provided to assist in screen navigation. For example, at least one set of up, down, right, and left keys may be provided. Additional keys may be provided as necessary and/or desired.

Input devices, including touchpad 230 and joystick/joypad 240 may be provided as necessary and/or desired. Additional input devices, including trackballs, mice, etc. may be provided as necessary and/or desired.

Any of the controls (e.g., keypad 220, touchpad 230, joystick 240, screen 210, button 290) may be positioned, oriented, etc. within kiosk 200 as necessary and/or desired to facilitate interaction with the customer.

In one embodiment, some or all of keypad 220, touchpad 230, and joystick 240 may be provided in a slide-out tray. In one embodiment, this tray may be activated upon entry of accessibility mode. In one embodiment, any or all of keypad 220, touchpad 230, and joystick 240 may be duplicated for the tray as necessary and/or desired.

In addition, any of keypad 220, touchpad 230, joystick 240, etc. may respond to the velocity of a customer's movements. For example, by the customer moving his or her fingers across the screen, touchpad, etc. more quickly, by holding down a key, by holding the joystick or joypad in one position, rotating the trackball quickly, etc. an indicator (e.g., a position indicator) on screen 210 may move more quickly.

In one embodiment, a round tracking device having a center button with a dial/scroller that has arrows too may be used. By the user moving his or her fingers faster, velocity may be detected.

In one embodiment, accessibility mode button 290 may be provided whereby depressing button 290 places the kiosk in accessibility mode.

In one embodiment, as will be described in greater detail below, screen 210 may include an accessibility icon that may also be used to place the kiosk in accessibility mode. In one embodiment, this may be displayed on the main screen and/or in a gutter portion of the screen.

In one embodiment, additional controls, such as foot switches, knee switches, etc. may be provided as is necessary and/or desired.

Kiosk 200 may further include camera 250, microphone 260 and speaker 270 for visually and audibly interacting with the customer. For example, in one embodiment, the camera may detect the presence of a customer at the kiosk, and may sense gestures, including sign language, motions, etc. In another embodiment, camera 250 may “read” the user's lips. Microphone 260 may receive audible commands from the customer, and speaker 270 may provide instructions and/or audible feedback to the customer.

In one embodiment, camera 250 may track the user's eyes. For example, in one embodiment, the user may be able to navigate the displayed contents by moving his or her eyes to look at the feature that he or she would like to access. In another embodiment, Google Glass or a similar device may be used to track the user's eyes and navigate the contents.

In one embodiment, in addition to, or in place of, microphone 260 and or speaker 270, at least one headphone jack (not shown) may be provided for receiving a headset, earphones, microphone, etc.

In one embodiment, speaker 270 may be used to provide verbal information to the customer. In one embodiment, sensitive information (e.g., account numbers, balances, etc.) may be displayed and not provided by speaker 270.

In one embodiment, speaker 270 may generate white noise to mask any audible communications between the customer and the kiosk. In another embodiment, additional speakers (not shown) may generate white noise to mask the communications to individuals outside kiosk 200. In one embodiment, masking may be used only for sensitive information. In another embodiment, microphone 260 and/or at least one additional microphone (not shown) may receive the audible communications, and a processor may generate an inverse signal that is output through speaker 270 and/or at least one additional speaker (not shown) to cancel the audio to those outside kiosk 200.

In one embodiment, any of camera 250, microphone 260, and sensors (not shown) may be used to place the kiosk into accessibility mode. For example, a customer may provide camera 250 with a gesture that causes the kiosk to enter accessibility mode. In another embodiment, the customer may provide verbal instructions to microphone 260 to enter accessibility mode.

In one embodiment, the customer may use gestures and/or verbal commands to interact with kiosk 200. In one embodiment, the customer may terminate accessibility mode and/or a session using gestures and/or verbal commands.

In one embodiment, any of these devices may be used to access whether or not a customer is likely to request accessibility mode based on the characteristics of the customer, and automatically enter that mode. For example, if the height of a customer is sensed to be below a threshold, the kiosk may automatically enter accessibility mode.

In another embodiment, sensors may detect the speed, gate, movement pattern, etc. at which the customer approaches and/or enters the kiosk. In one embodiment, based on the speed, gate, pattern, etc. detected by the sensors, the kiosk may automatically enter accessibility mode.

In another embodiment, a metal detector (not shown) may detect the presence of metal, indicating that a customer is in a wheelchair. The kiosk may then enter accessibility mode, and the height of displays, inputs, etc. may be so adjusted.

In one embodiment, if the sensors detect wheels, indicating a customer who is likely to be in a wheelchair or other mobility device, the kiosk may then enter accessibility mode.

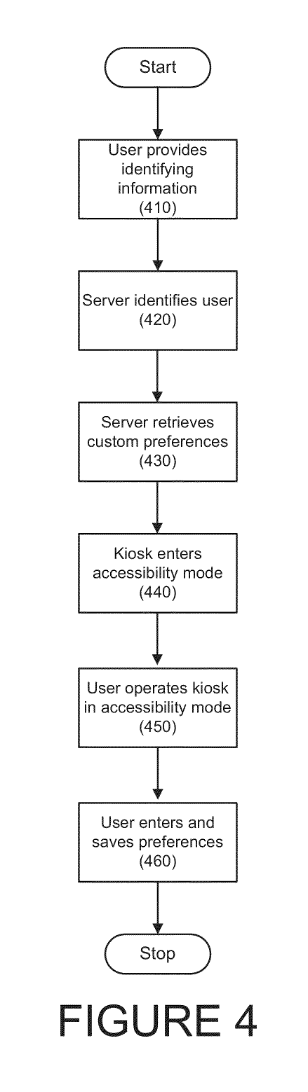

Referring to FIG. 4, a flowchart depicting a method of using an accessible kiosk according to one embodiment is provided. In step 410, the customer may provide identifying information to the kiosk. For example, the kiosk may read data from an identification card, such as a bank card, an access card, a credit card, etc. In another embodiment, the customer may enter identifying information to the kiosk. In another embodiment, the kiosk may scan a code that is on a card, device, etc. In still another embodiment, the kiosk may receive a biometric (e.g., voice, fingerprint, retina scan, etc.) from the customer. In another embodiment, the kiosk may use facial recognition to identify the customer. Any suitable method for identifying the customer may be used as necessary and/or desired.

In step 420, the kiosk and/or server may identify the customer based on the information provided. In one embodiment, this may involve retrieving data from the database. Any suitable method of identifying the customer based on received information may be used.

In step 430, the kiosk and/or server may retrieve any customer preferences. In one embodiment, these preferences may be retrieved from a database. For example, the customer may have set a preference that the kiosk enters accessibility mode. Other preferences, including default language, text size, color contrast (e.g., for color blind customers or customers that have difficulty seeing), preferred gestures, commands, audible interface, audio volume, etc. may be retrieved as necessary and/or desired.

In one embodiment, the customer may be able to “train” the kiosk to recognize his or her voice, and this training data may also be retrieved.

In step 440, if not already in accessible mode, the customer may instruct the kiosk and/or server to enter an “accessibility” mode. In one embodiment, the customer may press a button on the kiosk, such as a button on the kiosk itself. In another embodiment, the customer may depress an icon on a touch screen. In another embodiment, the customer may depress a button on a keypad. In still another embodiment, the customer may verbally instruct the kiosk to enter accessibility mode. In still another embodiment, the customer may gesture to the kiosk to enter accessibility mode. Other methods and techniques for entering accessibility mode may be used as necessary and/or desired.

In one embodiment, the kiosk may enter accessibility mode without instruction. For example, the kiosk may include a sensor, such as a camera, photodetectors, or any other device that can determine if a customer is likely to use accessibility mode. For example, if the customer is below a threshold height, the kiosk may default to accessibility mode.

In another embodiment, the kiosk may default to accessibility mode based on user preferences.

In still another embodiment, the kiosk may enter accessibility mode if it senses the presence of a human but receives no input. For example, if a user is detected for one minute, but the user has not taken any action, the kiosk may enter accessibility mode. In one embodiment, the kiosk may revert to standard mode when the presence of a human is no longer sensed, after the passage of additional time with no input, etc.

In step 450, the customer may operate the kiosk and/or server in accessibility mode. Exemplary operation of accessibility mode is described in greater detail, below.

In step 460, the customer may set any preferences as necessary and/or desired. In one embodiment, the customer may identify his or her disability. In another embodiment, the customer may set the preferred language, text size, font, color, contrast, brightness, etc. In one embodiment, the user may select an appropriate hatching for contrast for color blindness. In one embodiment, the customer may set screen position, screen size, data to be provided, etc. The customer may also set the desired interaction method (e.g., voice, keypad, touchscreen, joypad, gestures, etc.) and may “train” the kiosk to recognize commands, gestures, motions, etc. as necessary and/or desired. The customer may use these preferences for a single session, or may save them for future sessions.

In one embodiment, the customer may be presented with accessibility options that may be turned on or off. For example, the user may turn audible instruction on or off. In one embodiment, if an option is turned on, additional options may be provided to further customize the feature. For example, if audible instructions are turned on, the customer may select what instructions or data are read out loud, and which are only displayed (e.g., balances).

In one embodiment, the user's preferences may change based on the time of day. For example, a user may have an easier time seeing in the morning than in the evening. Thus, the user may set a higher contrast for when the user accesses the kiosk late in the day.

In one embodiment, the customer may set his or her preferences via, for example, a website. In another embodiment, the customer may set preferences on a mobile device, and the preferences may be transferred to the kiosk when the customer approaches the kiosk.

In one embodiment, the customer may exit accessibility mode in any suitable manner, including pressing a button, icon, giving a voice command, making a gesture, terminating the session (e.g., walking away from the kiosk), etc.

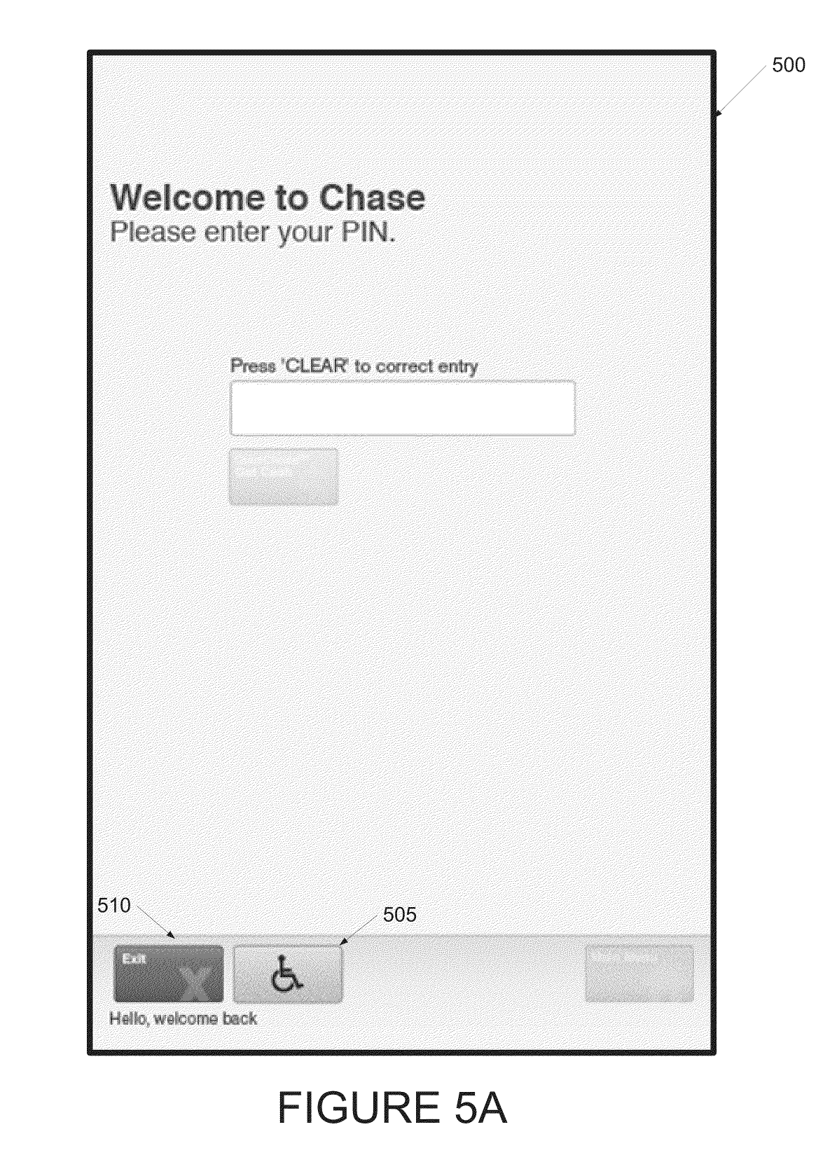

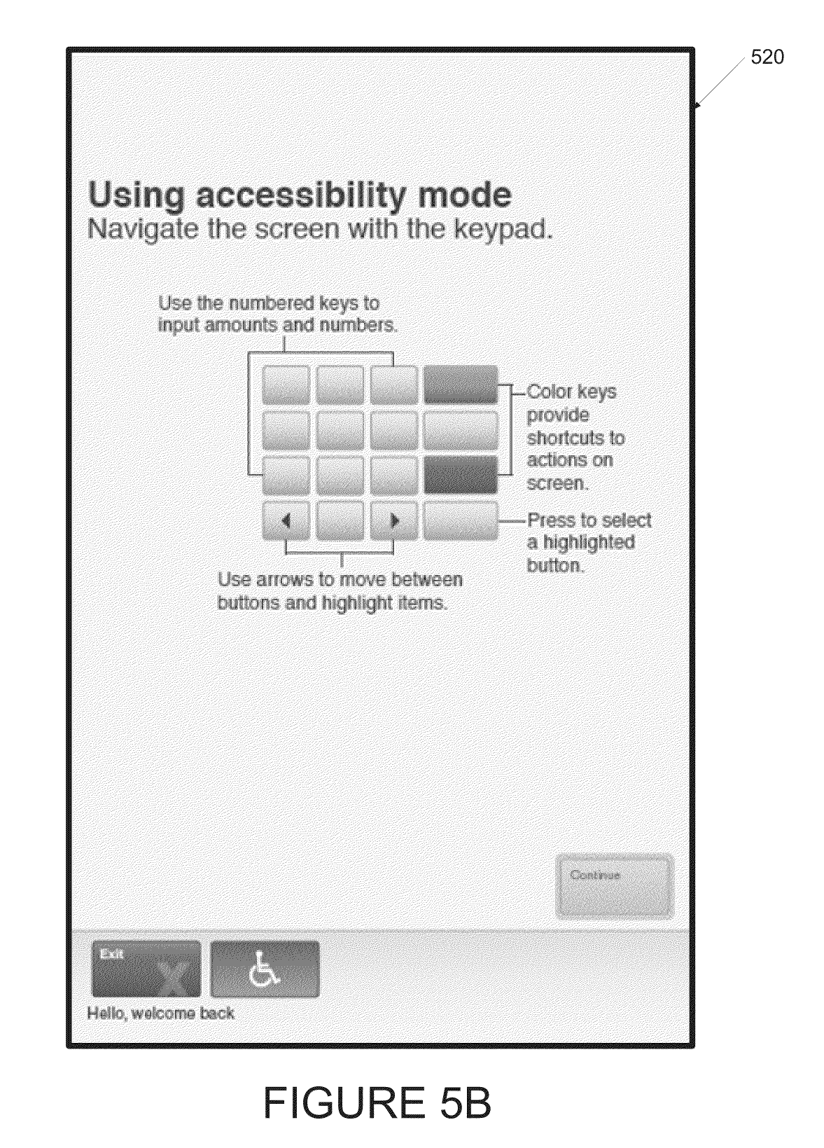

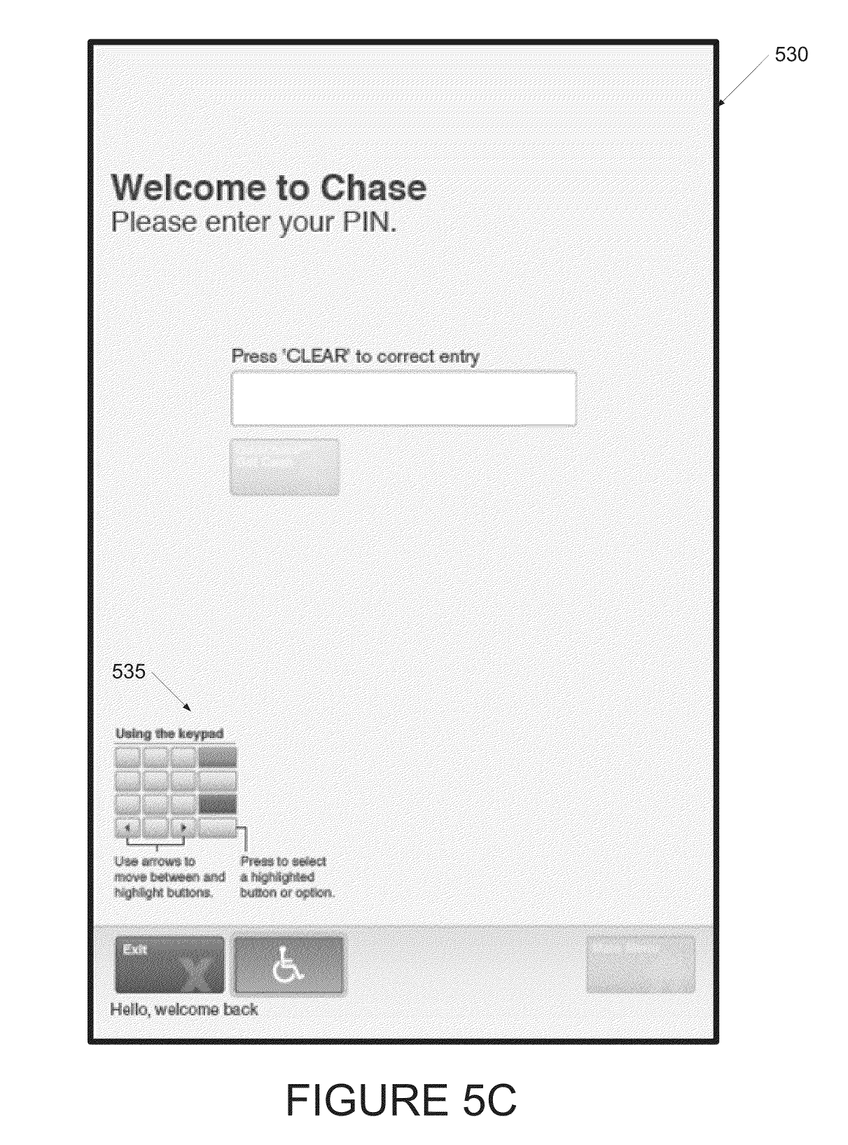

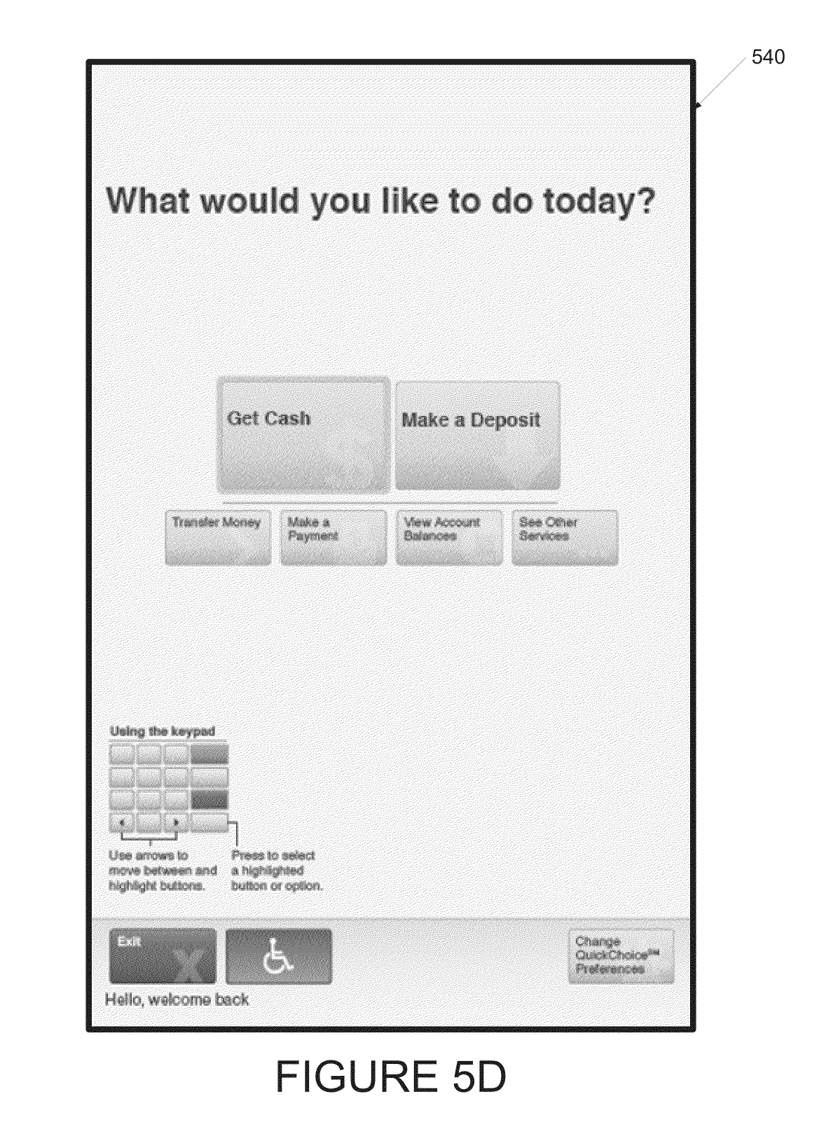

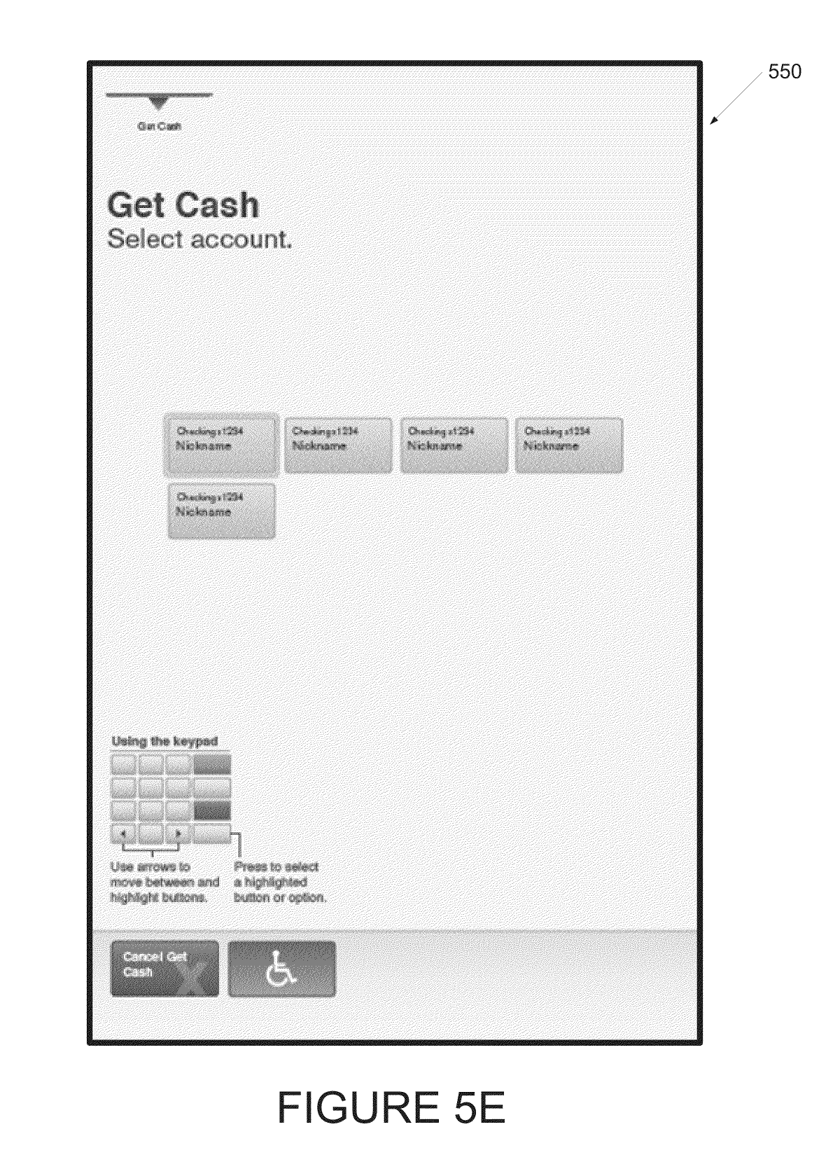

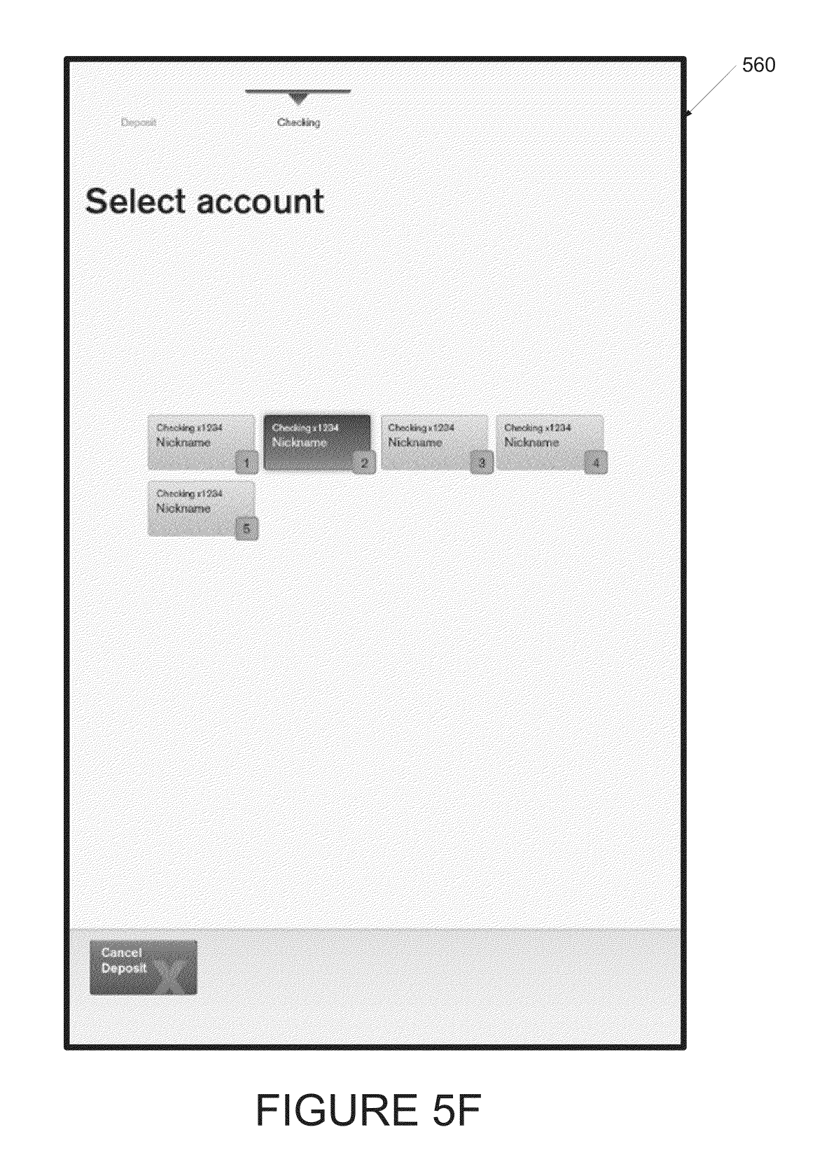

Referring to FIGS. 5A-5G, exemplary screenshots of a accessible kiosk according to one embodiment are provided. Although these figures are provided in the context of an automated teller machine, it should be recognized that this context is exemplary only.

FIG. 5A depicts an example of an initial screen that may be displayed on a screen of the kiosk. In one embodiment, initial screen 500 may be displayed whenever the kiosk is not in use. In another embodiment, initial screen 500 may be displayed when a customer approaches the kiosk.

In one embodiment, initial screen 500 may include a standard greeting, and may include a request for the entry of verification information, such as a personal identification number (PIN). In one embodiment, the customer may be presented with the option to enter accessibility mode. In one embodiment, touch-screen icon 505 may be provided. In another embodiment, a “hard” button (not shown) may be provided near, for example, the keypad. In another embodiment, a combination of icons and buttons may be provided. Icon 505 and/or any other button may be located at any suitable location on the screen and/or on the kiosk as necessary and/or desired.

In one embodiment, icon 505 may be provided in a separate display.

Icon 505 may be labeled in any suitable manner that indicates that its purpose is to enter accessibility mode. In one embodiment, ADA-compliant markings may be provided. In one embodiment, other marking, including braille, may be used as necessary and/or desired. In another embodiment, audible cues and/or additional visual cues may be provided as necessary and/or desired.

In one embodiment, an icon or button to exit accessibility mode, such as icon 510, may be provided.

Referring to FIG. 5B, exemplary instruction screen 520 for using accessibility mode is provided. In one embodiment, instruction screen 520 may provide instructions on how to navigate the screen using, for example, the keypad. In one embodiment, the number keys may be used in their standard manner for entering amounts, numbers, etc. Color keys, such as the keys depicted on the side of the keypad, may be used as shortcuts to actions on the screen. Arrows, such as a right and left arrow, may be used to cycle among different buttons and icons on the screen. In one embodiment, the arrow buttons may be used to highlight different icons or items, and a button may be depressed to select the highlighted icon or item.

In one embodiment, depending on the type of interface provided (e.g., directional keypad, joystick/joypad, touchpad, trackball, mouse, etc.), the instructions on how to use any other interface devices may be provided as necessary and/or desired. In one embodiment, a list of audible command, a depiction of gestures, etc. may be provided on the screen, as part of the kiosk, etc.

In one embodiment, audible instructions may be provided in addition to, or instead of, the instruction screen.

In one embodiment, a “practice mode” may be provide whereby the user can practice using the different interfaces.

In one embodiment, the user may select an icon, such as “continue,” to exit instruction screen 520.

Referring to FIG. 5C, after the customer exits the instruction screen, a modified screen, such as accessibility mode initial screen 530, may be provided. In one embodiment, screen 530 may include guide 535 that shows how to use the keypad or other navigation device to navigate the screen. In one embodiment, by “selecting” guide 535, the user may be returned to the screen of FIG. 5B.

Referring to FIG. 5D, after the user correctly enters his or her PIN or other identifier, the kiosk may provide different options. For example, screen 540 provides options, such as “Get Cash,” “Make A Deposit,” “Transfer Money,” “Make A Deposit,” “View Account Balances,” and “See Other Services.” Other options may be provided as necessary and/or desired. In one embodiment, the user may set his or her preference for which options are displayed, the order in which they are displayed, the size of each “button,” the color of each button, etc. when establishing his or her preferences.

In one embodiment, the “selected” option may be highlighted for the user. For example, in FIG. 5D, the “Get Cash” option is highlighted in gold; other colors and ways of indicating that this option is selected may be used as necessary and/or desired.

In one embodiment, the user may need to take an action (e.g., press a second button, gesture to the camera, provide a verbal instruction, etc.) to “activate” the selected option. For example, as shown in FIG. 5D, the user may press the bottom right button on the keypad to activate the “Get Cash” option.

FIG. 5E provides an example of screen 550 including a sub-menu for the “Get Cash” option. In one embodiment, the different option may be selected using the same technique as described above.

FIG. 5F provides a second example of screen 560 including a sub-menu for the “Get Cash” option. For example, each option may be associated with a number that may be selected using the keypad. In one embodiment, no additional action, such as depressing a second button, may be required. In one embodiment, the user may visually communicate his or her selection, for example, by holding up a corresponding number of fingers. In another embodiment, the user may verbally indicate his or her selection by, for example, speaking the number of the desired option. Other techniques and methods for selecting a desired option may be used as necessary and/or desired.

In one embodiment, the user may be able to “stage” a transaction on his or her mobile electronic device, and have it execute when the user approaches the kiosk.

In one embodiment, the kiosk may be provided with cleaning and/or sanitary features. The cleaning/sanitary features may be provided for the screen, for the input devices, etc. In one embodiment, the screen may be sealed, and following each customer, may be automatically cleaned with a sanitizing solution. In one embodiment, the screen may include a silver coating that may be energized for sanitization purposes.

In another embodiment, multiple screens (e.g., 2 or 3) may be provided and rotate following each customer. When the used screen is rotated, it is cleaned using, for example, a sanitizing solution, while a clean screen is provided for the next customer.

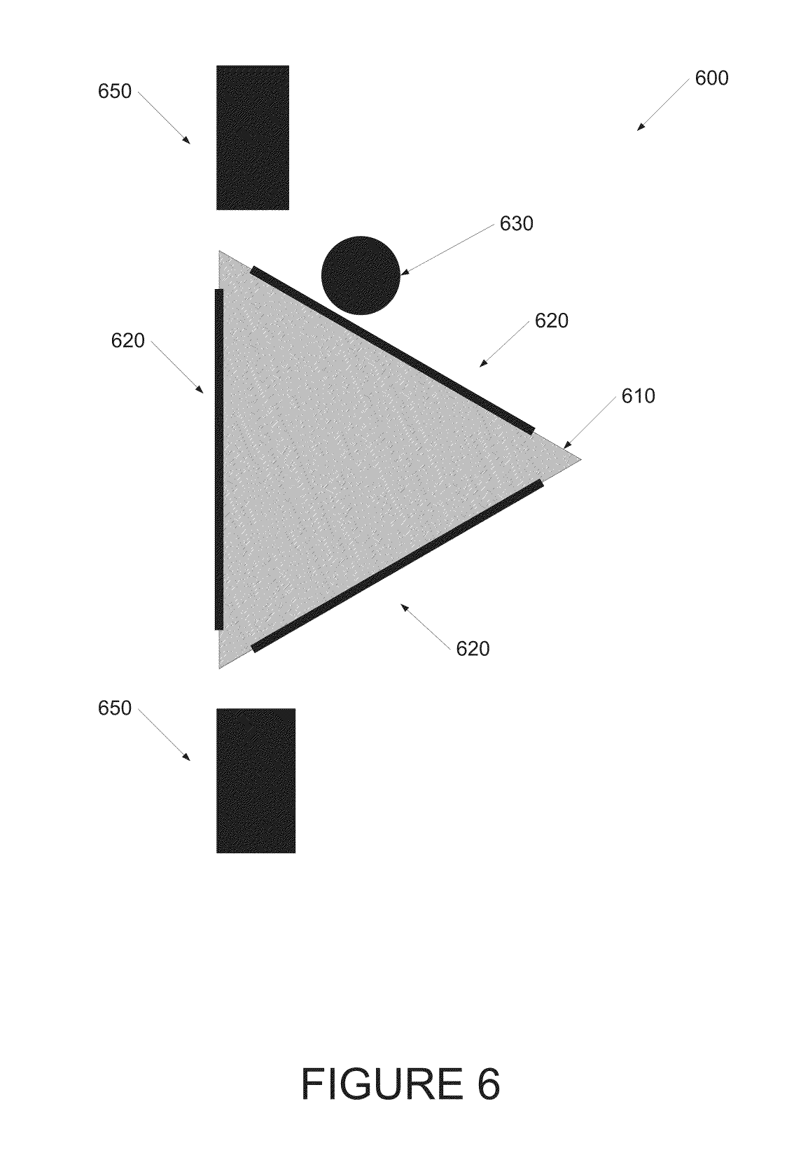

An exemplary embodiment of rotatable screen assembly 600 is provided in FIG. 6. Assembly 600 may include support structure 610 and screens 620. Although support structure 610 is illustrated as a triangle with three screens 620, it should be noted that any geometry for support structure 610 may be used, including rectangular (e.g., one or two screens), square (four screens), etc.

In one embodiment, support structure 610 may rotate around an axis at its center so that one of screen 620 is presented at the proper angle for a user.

Cleaning device 630 may be provided to clean screen 620 as it rotates behind the front of kiosk 650. In one embodiment, cleaning device 630 may “ride” on support structure 610 and screen 620 as they rotate.

In one embodiment, cleaning device 630 may be a roller moistened with a sanitizing solution. In another embodiment, cleaning device 630 may include a spray device and a wiping device.

In another embodiment, cleaning device 630 may be a heated roller. In another embodiment, cleaning device 630 may be a moistened towel or similar material to clean screen 620.

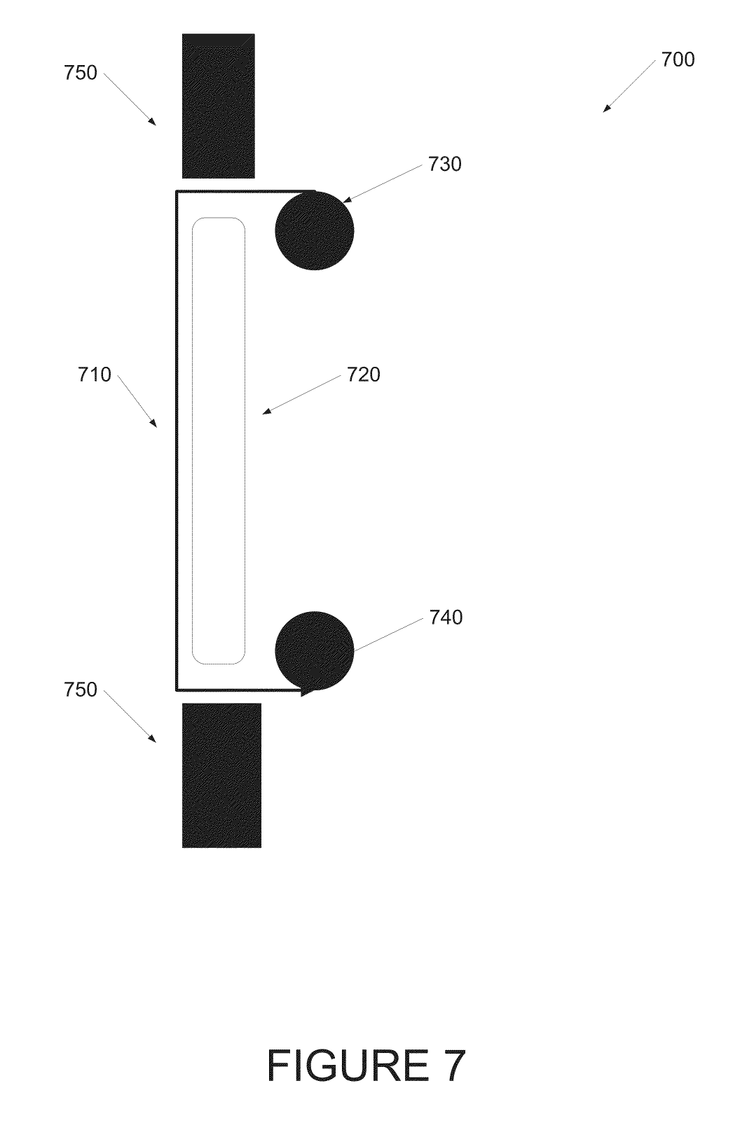

An exemplary embodiment of screen covering assembly 700 is provided in FIG. 7. The front side of screen 720 may be provided with film 710 that is supplied from supply reel 730 and taken up by take-up reel 740. Supply reel 730 and take-up reel 740 may be on the inside of kiosk 750.

In one embodiment, following each use by a customer, film 710 is advance from supply reel 730 and taken up by take-up reel 740. This may be accomplished by providing a motor (not shown) to rotate take-up reel 740 a certain number of rotation sufficient to draw sufficient film 710 from supply reel 730. Thus, each new customer will be presented with a sanitary interface for interacting with screen 710.

In one embodiment, a similar mechanism may be provided for a keypad, touch pad, or any other user interface as necessary and/or desired.

In another embodiment, anti-microbial materials, surfaces, coatings, etc. may be used for any parts of a kiosk, including interface devices (screen, keypad, buttons, joysticks, touchpads, etc.) as may be necessary and/or desired.

In another embodiment, ultraviolet lights may be provided within the kiosk to sanitize the kiosk following each use.

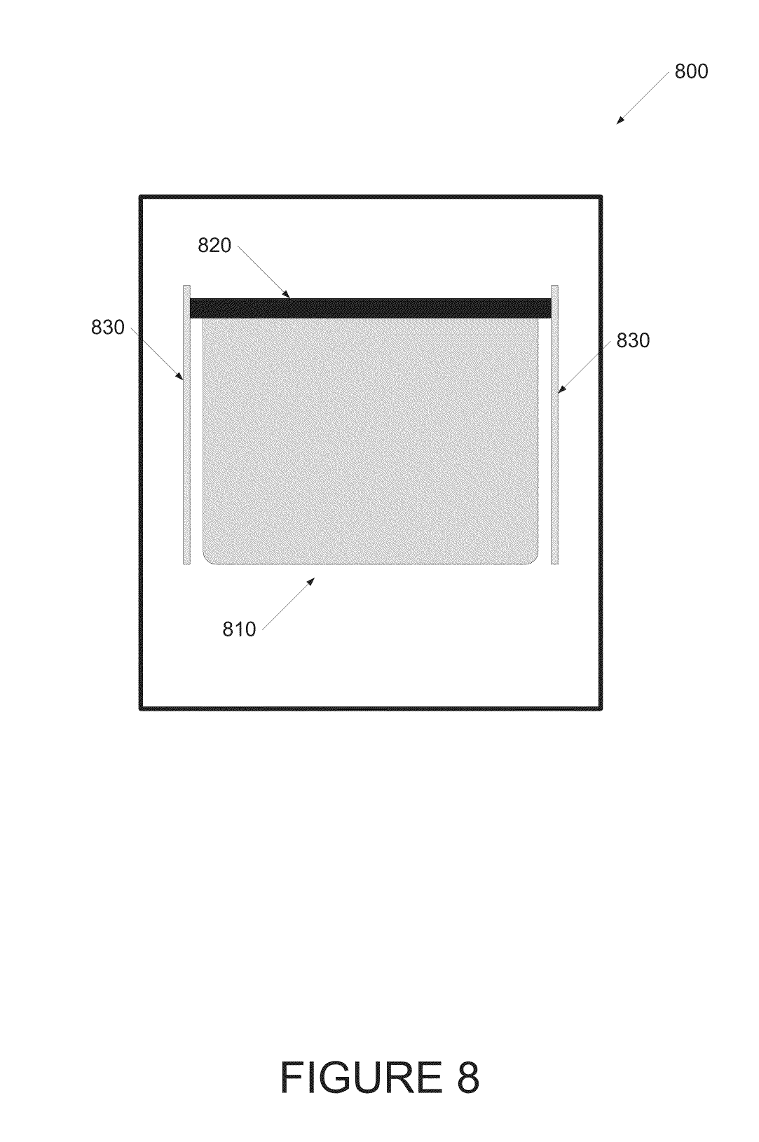

Referring to FIG. 8, an exemplary embodiment of a screen cleaning assembly is provided. Kiosk 800 includes screen 810, cleaning device 820, and tracks 830. In one embodiment, cleaning device 820 may be a roller moistened with a sanitizing solution. In another embodiment, cleaning device 820 may include a spray device and a wiping device.

In another embodiment, cleaning device 820 may be a heated roller. In another embodiment, cleaning device 820 may be a moistened towel or similar material to clean screen 810. In still another embodiment, cleaning device 810 may be a ultraviolet light. Other types of cleaning devices may be used as necessary and/or desired.

In one embodiment, cleaning device 820 may be guided by one or two tracks 830. In one embodiment, tracks 830 may be positioned on the side of screen 810.

In one embodiment, cleaning device 820 may retract into kiosk 810 when not in use.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for interacting with a user of an accessible self-service kiosk, comprising:
receiving, from a user, identifying information;
retrieving information about the user based on the identifying information;
receiving an instruction from the user to enter an accessibility mode; and
interacting with the user using an accessible interface.

2. The method of claim 1, wherein the identifying information is read from an identifying device.

3. The method of claim 2, wherein the identifying device is a transaction card.

4. The method of claim 3, wherein the identifying information is received from the identifying device without contact.

5. The method of claim 1, wherein the received information comprises at least one user accessible preference.

6. The method of claim 1, wherein the instruction to enter an accessibility mode is at least one of a gesture and a verbal command.

7. The method of claim 1, wherein the instruction is received on a keypad.

8. The method of claim 1, wherein the step of interacting with the user using an accessible interface comprises:
displaying to the user an instruction screen that includes instructions on how to interact with the self-service kiosk; and
displaying a guide to user interaction with the self-service kiosk on at least one additional screen.

9. The method of claim 1, further comprising:
providing white noise to a periphery of the self-service kiosk to mask audible communications between the user and the self-service kiosk.

10. A method for interacting with a user of an accessible self-service kiosk, comprising:
sensing, by at least one sensor, the presence of a user at a self-service kiosk;
determining, based on data from the at least one sensor, that the user is likely to use accessibility mode for interacting with the self-service kiosk; and
interacting with the user in the accessibility mode.

11. The method of claim 10, wherein the at least one sensor includes an infrared sensor that detects the presence of the user at the self-service kiosk.

12. The method of claim 10, wherein the at least one sensor includes a weight sensor that detects the presence of the user at the self-service kiosk.

13. The method of claim 10, wherein the at least one sensor senses a height of the user.

14. The method of claim 10, wherein the at least one sensor detects the presence of metal at the self-service kiosk.

15. The method of claim 13, wherein the accessibility mode is initiated when a sensed height of the user a threshold height.

16. The method of claim 14, wherein the accessibility mode is initiated when metal is detected.

17. The method of claim 14, wherein the accessibility mode is initiated when a certain movement is detected.

18. The method claim 10, wherein the step of interacting with the user in the accessibility mode comprises:
displaying to the user an instruction screen that includes instructions on how to interact with the self-service kiosk; and
displaying a guide to user interaction with the self-service kiosk on at least one additional screen.

19. The method claim 13, wherein the step of interacting with the user in the accessibility mode comprises:
adjusting a position of at least one display to accommodate the sensed height of the user.

20. The method claim 13, wherein the step of interacting with the user in the accessibility mode comprises:
adjusting a position of at least one controller to accommodate the sensed height of the user.

21. The method of claim 1, wherein the accessible interface is a keypad, and wherein the step of interacting with the user using an accessible interface comprises:
at least one computer processor assigning, to each of at least two keys on the keypad, a direction to move a cursor on a display in response to the respective key being actuated;
receiving a signal indicating that one of the keys was actuated; and
the at least one computer processor moving the cursor in the direction associated with the actuated key.

22. The method of claim 21, wherein the keypad is a numeric keypad.

23. The method of claim 22, further comprising:
toggling a functionality of the numeric keypad between number entry and cursor movement entry.

24. The method claim 13, wherein the step of interacting with the user in the accessibility mode comprises:
at least one computer processor assigning, to each of at least two keys on a keypad, a direction to move a cursor on a display in response to the respective the key being actuated.

25. The method of claim 24, wherein the keypad is a numeric keypad.

26. The method of claim 25, further comprising:
toggling a functionality of the numeric keypad between number entry and cursor movement entry.

27. The method of claim 21, wherein the at least one computer processor assigns a direction to move the cursor to four keys on the keypad.

28. The method of claim 21, further comprising:
the at least one computer processor assigning, to one key on the keypad, an execution function, where a feature highlighted by the cursor on the display is executed when the execution function is actuated.

29. The method of claim 24, wherein the at least one computer processor assigns a direction to move the cursor to four keys on the keypad.

30. The method of claim 24, further comprising:
the at least one computer processor assigning, to one key on the keypad, an execution function, where a feature highlighted by the cursor on the display is executed when the execution function is actuated.
